(19) United States
(12) Patent Application Publication
(10) Pub. No.: US 2016/0137125 A1
(43) Pub. Date: May 19, 2016

(54) IMAGING SYSTEM USING VIRTUAL PROJECTION GEOMETRY

(71) Applicant: Caterpillar Inc., Peoria, IL (US)

(72) Inventors: Peter Joseph Petrany, Dunlap, IL (US); Bradley Scott Kriel, Pittsburgh, PA (US); Paul Edmund Rybski, Pittsburgh, PA (US); Douglas Jay Husted, Secor, IL (US); Tod Andrew Oblak, Pittsburgh, PA (US)

(73) Assignee: CATERPILLAR INC., Peoria, IL (US)

(21) Appl. No.: 14/543,141

(22) Filed: Nov. 17, 2014

(51) Int. Cl. B60R 1/00; B60R 11/00; H04N 7/18

(52) U.S. Cl. CPC B60R 1/00; H04N 7/183; B60R 11/00; B60R 2300/10; B60R 2300/20

(57) ABSTRACT

An imaging system is disclosed for use with a mobile machine. The imaging system may have at least one onboard camera configured to generate image data for an actual environment of the mobile machine, and an onboard sensor configured to generate object data regarding detection and ranging of an object in the actual environment. The imaging system may also have a display mounted on the machine, and a processor in communication with the at least one camera, the sensor, and the display. The processor may be configured to generate a virtual geometry, and generate a virtual object within the virtual geometry based on the object data. The processor may further be configured to generate a unified image of the actual environment based on the image data, to map a projection of the unified image onto the virtual geometry and the virtual object, and to render a selected portion of the projection on the display.

### TECHNICAL FIELD

The present disclosure relates generally to an imaging system, and more particularly, to an imaging system using a virtual projection geometry.

### BACKGROUND

Excavation machines such as haul trucks, wheel loaders, scrapers, and other types of heavy equipment, are used to perform a variety of tasks. Some of these tasks involve carrying large, awkward, loose, and/or heavy loads along rough and crowded roadways. And because of the size of the machines and/or poor visibility provided to operators of the machines, these tasks can be difficult to complete effectively. For this reason, some machines are equipped with image systems that provide views of a machine's environment to the operator.

Conventional imaging systems include one or more cameras that capture different sections of the machine's environment. These sections are then stitched together to form a partial or complete surround view, with the associated machine being located at a center of the view. While effective, these types of systems can also include image distortions that increase in severity the further that objects in the captured image are away from the machine.

One attempt to reduce image distortions in the views provided to a machine operator is disclosed in U.S. Patent Application Publication 2014/0204215 of KRIEL at al, which published Jul. 24, 2014 (the '215 publication). In particular, the '215 publication discloses an image processing system having a plurality of cameras and a display that are mounted on a machine. The cameras generate image data for an environment of the machine. The image processing system also has a processor that generates a unified image of the environment by combining image data from each of the cameras and mapping pixels associated with the data onto a hemispherical pixel map. In the hemispherical pixel map, the machine is located at the pole. The processor then sends selected portions of the hemispherical map to be shown inside the machine on the display.

While the system of the '215 publication may reduce distortions by mapping the data pixels onto a hemispherical map, the system may still be improved upon. In particular, the system may still show distortions of the environment at locations of large objects in the environment.

The disclosed system is directed to overcoming one or more of the problems set forth above and/or other problems of the prior art.

### SUMMARY

In one aspect, the present disclosure is directed to an imaging system for a mobile machine. The imaging system may include at least one camera mounted on the mobile machine and configured to generate image data for an actual environment of the mobile machine, and a sensor mounted on the mobile machine and configured to generate object data regarding detection and ranging of an object in the actual environment. The imaging system may also include a display mounted on the mobile machine, and a processor in communication with the at least one camera, the sensor, and the display. The processor may be configured to generate a virtual geometry, to generate a virtual object within the virtual geometry based on the object data, and to generate a unified image of the actual environment based on the image data. The processor may also be configured to map a projection of the unified image onto the virtual geometry and the virtual object, and to render a selected portion of the projection on the display.

In another aspect, the present disclosure is directed to a method of displaying an actual environment around a mobile machine. The method may include capturing images of the actual environment around the mobile machine, and detecting and ranging an object in the actual environment. The method may further include generating a virtual geometry, generating a virtual object within the virtual geometry based on detection and ranging of the object in the actual environment, and generating a unified image of the actual environment based on captured images of the environment. The method may also include mapping a projection of the unified image onto the virtual geometry, and rendering a selected portion of the projection.

In yet another aspect, the present disclosure is directed to a computer readable medium having executable instructions stored thereon for performing a method of displaying an actual environment around a mobile machine. The method may include capturing images of the actual environment around the mobile machine, and detecting and ranging an object in the actual environment. The method may further include generating a virtual geometry, generating a virtual object within the virtual geometry based on detection and ranging of the object in the actual environment, and generating a unified image of the actual environment based on captured images of the actual environment. The method may also include mapping a projection of the unified image onto the virtual geometry, and rendering a selected portion of the projection.

### BRIEF DESCRIPTION OF THE DRAWINGS

FIG. 1 is a pictorial illustration of an exemplary disclosed machine; and

FIG. 2 is a diagrammatic illustration of an exemplary disclosed imaging system that may be used in conjunction with the machine of FIG. 1.

### DETAILED DESCRIPTION

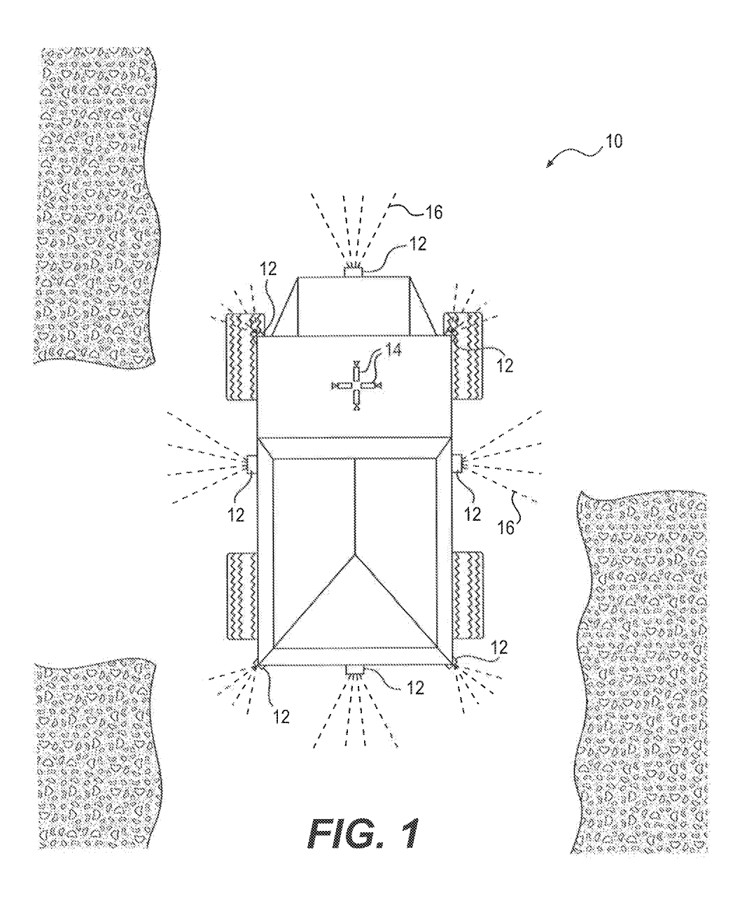

FIG. 1 illustrates an exemplary machine 10 having multiple systems and components that cooperate to accomplish a task. Machine 10 may embody a mobile machine that performs some type of operation associated with an industry such as mining, construction, fanning, transportation, or any other industry known in the art. For example, machine 10 may be an earth moving machine such as a haul truck (shown in FIG. 1), an excavator, a dozer, a loader, a backhoe, a motor grader, or any other earth moving machine. Machine 10 may include one or more detection and ranging devices (“devices”) 12 and any number of cameras 14. Devices 12 and cameras 14 may be active during operation of machine 10, for example as machine 10 moves about an area to complete its assigned tasks such as digging, hauling, dumping, ripping, shoveling, or compacting different materials.

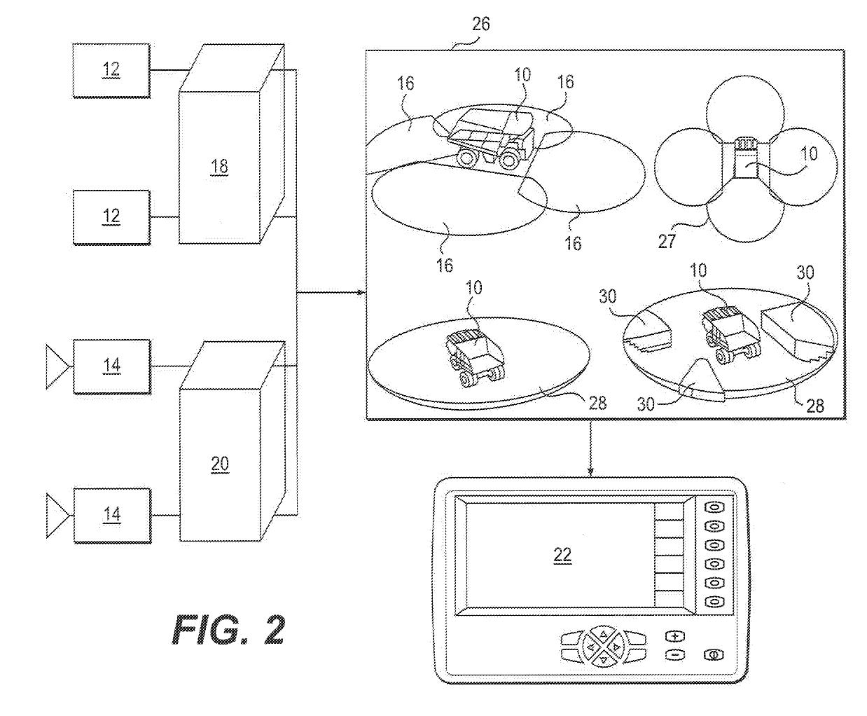

Machine 10 may use devices 12 to generate object data associated with objects in their respective fields of view 16. Devices 12 may each be any type of sensor known in the art for detecting and ranging (locating) objects. For example, radio detecting and ranging (RADAR) devices may be used, sound navigation and ranging (SONAR) devices may be used, light detection and ranging (LIDAR) devices may be used, radio-frequency identification (RFID) devices may be used, time-of-flight devices may be used, cameras may be used, and/or global position satellite (GPS) devices may be used to detect objects in the actual environment of machine 110. During operation of machine 10, one or more systems of machine 10, for example a DAR (Detection And Ranging) interface 18 (shown only in FIG. 2), may process the object data received from these devices 12 to size and range (i.e., to locate) the objects.

Camera(s) 14 may be attached to the frame of machine 10 at any desired location, for example at a high vantage point near an outer edge of machine 10. Machine 10 may use camera(s) 14 to generate image data associated with the actual environment in their respective fields of view 16. The images may include, for example, video or still images. During operation, one or more systems of machine 10, for example a camera interface 20 (shown only in FIG. 2), may process the image data in preparation for presentation on a display 22 (e.g., a 2-D or 3-D monitor shown only in FIG. 2) located inside machine 10.

While machine 10 is shown having eight devices 12 each responsible for a different quadrant of the actual environment around machine 10, and also four cameras 14, those skilled in the art will appreciate that machine 10 may include any number of devices 12 and cameras 14 arranged in any manner. For example, machine 10 may include four devices 12 on each side of machine 10 and/or additional cameras 14 located at different elevations.

FIG. 2 is a diagrammatic illustration of an exemplary imaging system 24 that may be installed on machine 10 to capture and process image data and object data in the actual environment of machine 10. Imaging system 24 may include one or more modules that, when combined, perform object detection, image processing, and image rendering. For example, as illustrated in FIG. 2, imaging system 24 may include devices 12, cameras 14, DAR interface 18, camera interface 20, display 22, and an image processor 26. While FIG. 2 shows the components of imaging system 24 as separate blocks, those skilled in the art will appreciate that the functionality described below with respect to one component may be performed by another component, or that the functionality of one component may be performed by two or more components.

According to some embodiments, the modules of imaging system 24 may include logic embodied as hardware, firmware, or a collection of software written in a programming language. The modules of imaging system 24 may be stored in any type of computer-readable medium, such as a memory device (e.g., random access, flash memory, and the like), an optical medium (e.g., a CD, DVD, BluRay®, and the like), firmware (e.g., an EPROM), or any other storage medium. The modules may be configured for execution by processor 26 to cause imaging system 24 to perform particular operations. The modules of the imaging system 24 may also be embodied as hardware modules and may be comprised of connected logic units, such as gates and flip-flops, and/or may be comprised of programmable units, such as programmable gate arrays or processors, for example.

In some aspects, before imaging system 24 can process object data from devices 12 and/or image data from cameras 14, the object and/or image data must first be converted to a format that is consumable by the modules of imaging system 24. For this reason, devices 12 may be connected to DAR interface 18, and cameras 14 may be connected to camera interface 20. DAR interface 18 and camera interface 20 may each receive analog signals from their respective devices, and convert them to digital signals that may be processed by the other modules of imaging system 24.

DAR interface 18 and/or camera interface 20 may package the digital data in a data package or data structure, along with metadata related to the converted digital data. For example, DAR interface 18 may create a data structure or data package that has metadata and a payload. The payload may represent the object data from devices 12. Non-exhaustive examples of the metadata may include the orientation of device 12, the position of device 12, and/or a time stamp for when the object data was recorded. Similarly, camera interface 20 may create a data structure or data package that has metadata and a payload representing image data from camera 14. This metadata may include parameters associated with camera 14 that captured the image data. Non-exhaustive examples of the parameters associated with camera 14 may include the orientation of camera 14, the position of camera 14 with respect to machine 10, the down-vector of camera 14, the range of the camera's field of view 16, a priority for image processing associated with camera 14, and a time stamp for when the image data was recorded. Parameters associated with camera 14 may be stored in a configuration file, database, data store, or some other computer readable medium accessible by camera interface 20. The parameters may be set by an operator prior to operation of machine 10.

In some embodiments, devices 12 and/or cameras 14 may be digital devices that produce digital data, and DAR interface 18 and camera interface 20 may package the digital data into a data structure for consumption by the other modules of imaging system 24. DAR interface 18 and camera interface 20 may include an application program interface (API) that exposes one or more function calls, allowing the other modules of imaging system 24 to access the data.

Based on the object data from DAR interface 18, processor 26 may be configured to detect objects in the actual environment surrounding machine 10. Processor 26 may access object data by periodically polling DAR interface 18 for the data. Processor 26 may also or alternatively access the object data through an event or interrupt triggered by DAR interface 18. For example, when device 12 detects an object larger than a threshold size, it may generate a signal that is received by DAR interface 18, and DAR interface 18 may publish an event indicating detection of a large object. Processor 26, having registered for the event, may responsively receive the object data and analyze the payload of the object data. In addition to the orientation and position of device 12 that detected the object, the payload of the object data may also indicate a location within the field of view 16 where the object was detected. For example, the object data may indicate the distance and angular position of the detected object relative to a known location of machine 10.

Processor 26 may combine image data received from multiple cameras 14 via camera interface 20 into a unified image 27. Unified image 27 may represent all image data available for the actual environment of machine 10, and processor 26 may stitch the images from each camera 14 together to create a 360-degree view of the actual environment of machine 10. Machine 10 may be at a center of the 360-degree view in unified image 27.

Processor 26 may use parameters associated with individual cameras 14 to create unified image 27. The parameters may include, for example, the position of each camera 14 onboard machine 10, as well as a size, shape, location, and/or orientation of the corresponding field of view 16. Processor 26 may then correlate sections of unified image 27 with the camera locations around machine 10, and use the remaining parameters to determine where to place the image data from each camera 14. For example, processor 26 may correlate a forward section of the actual environment with the front of machine 10 and also with a particular camera 14 pointing in that direction. Then, when processor 26 subsequently receives image data from that camera 14, processor 26 may determine that the image data should be mapped to the particular section of unified image 27 at the front of machine 10. Thus, as processor 26 accesses image data from each of cameras 14, processor 26 can correctly stitch it in the right section of unified image 27.

In some applications, the images captured by the different cameras 14 may overlap somewhat, and processor 26 may need to discard some image data in the overlap region in order to enhance clarity. Any strategy known in the art may be used for this purpose. For example, cameras 14 may he prioritized based on type, location, age, functionality, quality, definition, etc., and the image data from the camera 14 having the lower priority may be discarded from the overlap region. In another example, the image data produced by each camera 14 may be continuously rated for quality, and the lower quality data may be discarded. Other strategies may also be employed for selectively discarding image data. It may also he possible to retain and use the overlapping composite image, if desired.

In the disclosed embodiment, processor 26 may generate a virtual three-dimensional surface or other geometry 28, and mathematically project the digital image data associated with unified image 27 onto geometry 28 to create a unified 3-D surround image of the machine environment. Geometry 28 may be generally hemispherical, with machine 10 being located at an internal pole or center. Geometry 28 may he created to have any desired parameters, for example a desired diameter, a desired wall height, etc. Processor 26 may mathematically project unified image 27 onto geometry 28 by transferring pixels of the 2-D digital image data to 3-D locations on geometry 28 using a predefined pixel map or look-up table stored in a computer readable data store or configuration file that is accessible by processor 26. The digital image data may be mapped directly using a one-to-one or a one-to-many correspondence. It should be noted that, although a look-up table is one method by which processor 26 may create a 3-D surround view of the actual environment of machine 10, those skilled in the relevant art will appreciate that other methods for mapping image data may be used to achieve a similar effect.

In some instances, for example when large objects exist in the near vicinity of machine 10, the image projected onto geometry 28 could have distortions at the location of the objects. Processor 26 may he able to enhance the clarity of unified image 27 at these locations by selectively altering geometry 28 used for projection of unified image 27 (i.e., by altering the look-up table used for the mapping of the 2-D unified image 27 into 3-D space). In particular, processor 26 may he configured to generate virtual objects 30 within geometry 28 based on the object data captured by devices 12. Processor 26 may generate virtual objects 30 of about the same size as actual objects detected in the actual environment of machine 10, and mathematically place objects 30 at the same general locations within the hemispherical virtual geometry 28 relative to the location of machine 10 at the pole. Processor 26 may then project unified image 27 onto the object-containing virtual geometry 28. In other words, processor 26 may adjust the lookup table used to map the 2-D image into 3-D space to account for the objects. As described above, this may be done for all objects larger than a threshold size, so as to reduce computational complexity of imaging system 24.

Processor 26 may render a portion of unified image 27 on display 22, after projection of image 27 onto virtual geometry 28. The portion rendered by processor 26 may be automatically selected or manually selected, as desired. For example, the portion may be automatically selected based on a travel direction of machine 10. In particular, when machine 10 is traveling forward, a front section of the as-projected unified image 27 may be shown on display 22. And when machine 10 is traveling backward, a rear section may be shown. Alternatively, the operator of machine 10 may be able to manually select a particular section to be shown on display 22. In some embodiments, both the automatic and manual options may be available.

### INDUSTRIAL APPLICABILITY

The disclosed imaging system may be applicable to any machine that includes cameras. The disclosed imaging system may enhance a surround view provided to the operator of the machine from the cameras by accounting for large objects that otherwise would normally distort the view. In particular, the disclosed imaging system may generate a hemispherical virtual geometry, including virtual objects at detected locations of actual objects in the actual environment. The disclosed imaging system may then mathematically project a unified image (or collection of individual images) onto the virtual geometry including virtual objects, and render the resulting projection.

Because the disclosed imaging system may project actual images onto irregular virtual objects protruding from a hemispherical virtual geometry, a greater depth perception may be realized in the resulting projection. This greater depth perception may reduce the amount of distortion demonstrated in the surround view when large objects are in the near vicinity of the machine.

It will be apparent to those skilled in the art that various modifications and variations can be made to the disclosed imaging system. Other embodiments will be apparent to those skilled in the art from consideration of the specification and practice of the disclosed imaging system. It is intended that the specification and examples be considered as exemplary only, with a true scope being indicated by the following claims and their equivalents.

What is claimed is:

1. An imaging system for a mobile machine, comprising:
at least one camera mounted on the mobile machine, the at least one camera configured to generate image data for an actual environment of the mobile machine;
a sensor mounted on the mobile machine and configured to generate object data regarding detection and ranging of an object in the actual environment;
a display mounted on the mobile machine; and
a processor in communication with the at least one camera, the sensor, and the display, the processor being configured to:
generate a virtual geometry;
generate a virtual object within the virtual geometry based on the object data;
generate a unified image of the actual environment based on the image data;
map a projection of the unified image onto the virtual geometry and the virtual object; and
render a selected portion of the projection on the display.

2. The imaging system of claim 1, wherein the virtual geometry is generally hemispherical.

3. The imaging system of claim 1, wherein the processor is configured to generate the virtual object based on object data associated with only objects in the actual environment that are larger than a size threshold.

4. The imaging system of claim 3, wherein the processor is configured to generate multiple virtual objects for all objects in the actual environment of the mobile machine that are larger than the size threshold.

5. The imaging system of claim 1, wherein the selected portion of the projection that is rendered on the display is manually selected by an operator of the mobile machine.

6. The imaging system of claim 1, wherein the selected portion of the projection that is rendered on the display is automatically selected based on a travel direction of the mobile machine.

7. The imaging system of claim 1, wherein:
the sensor is a first sensor configured to detect and range objects in a first quadrant of the actual environment;
the imaging system further includes at least one additional sensor configured to detect and range objects in another quadrant of the actual environment; and
the processor is configured to generate virtual objects within the virtual geometry representative of objects detected by the first sensor and the at least one additional sensor.

8. The imaging system of claim 1, wherein the sensor is one of a RADAR sensor, a LIDAR sensor, a SONAR sensor, a time-of-flight device, and a camera.

9. The imaging system of claim 1, wherein the unified image includes a 360° view around the mobile machine.

10. .A method of displaying an actual environment around a mobile machine, comprising:
capturing images of the actual environment around the mobile machine;
detecting and ranging an object in the actual environment;
generating a virtual geometry;
generating a virtual object within the virtual geometry based on detection and ranging of the object in the actual environment;
generating a unified image of the actual environment based on captured images of the actual environment;
mapping a projection of the unified image onto the virtual geometry; and
rendering a selected portion of the projection.

11. The method of claim 10, wherein mapping the projection of the unified image onto the virtual geometry includes mapping the projection onto a generally hemispherical virtual geometry.

12. The method of claim 10, wherein generating the virtual object within the virtual geometry includes generating the virtual object within the virtual geometry only when the object in the actual environment is larger than a size threshold.

13. The method of claim 12, wherein generating the virtual object within the virtual geometry includes generating multiple virtual objects for all objects in the actual environment of the mobile machine that are larger than the size threshold.

14. The method of claim 10, wherein rendering the selected portion of the projection includes rendering a portion of the projection that is manually selected by an operator of the mobile machine.

15. The method of claim 10, wherein rendering the selected portion of the projection includes automatically rendering a portion of the projection based on a travel direction of the mobile machine.

16. The method of claim 10, wherein detecting and ranging an object in the actual environment includes detecting and ranging multiple objects located in different quadrants of the actual environment from multiple different locations onboard the mobile machine.

17. The method of claim 10, wherein generating the unified image of the actual environment includes generating a 360° view around the mobile machine.

18. A computer programmable medium having executable instructions stored thereon for completing a method of displaying an actual environment around a mobile machine, the method comprising:
capturing images of an actual environment around a mobile machine;
detecting and ranging an object in the actual environment;
generating a virtual geometry;
generating a virtual object within the virtual geometry based on detection and ranging of the object in the actual environment;
generating a unified image of the actual environment based on captured images of the actual environment;
mapping a projection of the unified image onto the virtual geometry; and
rendering a selected portion of the projection.

19. The computer programmable medium of claim 18, wherein:
mapping the projection of the unified image onto the virtual geometry includes mapping the projection onto a generally hemispherical virtual geometry; and
generating the virtual object within the virtual geometry includes generating the virtual object within the virtual geometry only when the object in the actual environment is larger than a size threshold.

20. The computer programmable medium of claim 18, wherein generating the unified image of the actual environment includes generating a 360° view around the mobile machine.
